(19) United States
(12) Patent Application Publication
(10) Pub. No.: US 2026/0316628 A1
(43) Pub. Date: Oct. 15, 2026

(54) MOTOR VEHICLE ENERGY SYSTEM

(71) Applicant: AUDI AG, Ingolstadt (DE)

(72) Inventor: Uwe FELDMANN, Nassenfels (DE)

(73) Assignee: AUDI AG, Ingolstadt (DE)

(21) Appl. No.: 19/638,687

(22) Filed: Apr. 3, 2026

(30) Foreign Application Priority Data
Apr. 9, 2025 (DE) 102025114019.7

(51) Int. Cl. B60L 58/20; B60K 1/04; B60L 53/10; B60L 53/53; B60L 58/12

(52) U.S. Cl. CPC B60L 58/20; B60K 1/04; B60L 53/11; B60L 53/53; B60L 58/12; B60K 2001/0416; B60L 2210/10; B60L 2240/12; B60L 2240/547; B60L 2240/62

(57) ABSTRACT

A motor vehicle energy system has a first circuit having a first battery for supplying a traction drive of a motor vehicle with electrical energy; a second battery; a connecting apparatus for connecting the first circuit and the second battery, which has a transfer operating state for transferring electrical energy from the first circuit to the second battery; and a controller for switching the connecting apparatus into this transfer operating state on the basis of a predicted imminent charging process of the first and/or second battery.

### FIELD

The present invention relates to a motor vehicle energy system, a motor vehicle having the motor vehicle energy system, a method for operating the motor vehicle energy system, and a computer program or computer program product for carrying out the method.

### BACKGROUND

In motor vehicles having a traction drive and a battery for supplying the traction drive with electrical energy, for example a battery electric vehicle or a hybrid electric vehicle, in particular a plug-in hybrid electric vehicle, operation can be improved by an additional further battery.

### SUMMARY

The object of the present invention is to improve the operation of a motor vehicle having a battery for supplying a traction drive with electrical energy and an additional further battery.

This object is achieved by a motor vehicle energy system a method for operating a motor vehicle energy system, or a computer program or computer program product for carrying out the method.

According to one embodiment of the present invention, an energy system for a motor vehicle (“motor vehicle energy system”), in a further development a motor vehicle energy system of a motor vehicle, comprises:
a first circuit, which in turn has a first battery, preferably a drive or traction battery, which at least temporarily supplies or is configured to supply or is used to supply a traction drive of the motor vehicle, which preferably has one or more electric motors for driving, in particular accelerating, the motor vehicle, with electrical energy;
a second battery, preferably a range extender battery;
a connecting apparatus,
which at least temporarily (electrically) connects or is configured to connect or is used to connect the first circuit, in particular the first battery and/or the traction drive, and the second battery to one another; and
via which, in a transfer operating state of the connecting apparatus, electrical energy is at least temporarily transferred or (electrically) transmitted from the first circuit, in particular the first battery, to the second battery, or which is configured to do so or is used to do so; and
a controller, which switches the connecting apparatus into this transfer operating state on the basis of a predicted imminent charging process of the first and/or second battery, preferably as a result of a predicted imminent charging process of the first and/or second battery or if an imminent charging process of the first and/or second battery is or has been predicted, or which is configured to do so, in particular in terms of hardware and/or software, in particular in terms of programming.

A predicted imminent charging process is, in one embodiment, a charging process predicted as imminent, preferably a charging process of the first battery or the second battery and particularly preferably of the first and second battery at least partially together or simultaneously, via a charging interface of the first circuit and/or a charging station (vehicle-external, in one embodiment stationary), preferably temporarily coupled thereto, for example a charging column, wall charging station (“wallbox”) or the like. In one embodiment, the motor vehicle energy system, in particular the first circuit, has the traction drive, in a further development one or the electric motor(s) and/or one or more power converters, preferably inverters, for operating this or these electric motors.

One embodiment is based on the idea of proactively transferring electrical energy from the first battery to the second battery before a charging process, so that during the subsequent charging process more energy is or must be charged into the first battery and less energy into the second battery. This can in particular protect the second battery.

In one embodiment, the first circuit has a charging interface for charging the first battery, preferably via a charging station, the connecting apparatus has a charging operating state in which the second battery is at least temporarily (electrically) charged via the connecting apparatus at least temporarily via the charging interface and the connecting apparatus, preferably at least partially together or simultaneously with the first battery, or the connecting apparatus is configured to do so or is used to do so, and the controller switches the connecting apparatus, in one embodiment after termination of the transfer operating state, at least temporarily into this charging operating state, preferably on the basis of a state of charge of the first and/or second battery, in one embodiment if a state of charge of the first battery falls below a predefined limit value and/or a state of charge of the second battery exceeds a predefined limit value, and/or if a charging process is initiated, or is configured to do so, in particular in terms of hardware and/or software, in particular in terms of programming.

If the connecting apparatus is (also) used to charge the second battery via the charging interface during a charging process, the prior transmitting of electrical energy from the first circuit to the second battery before this charging process can relieve the connecting apparatus during the charging process and thereby advantageously allow it to be designed to be simpler, smaller and/or less powerful as the case may be.

The charging of the first and second battery via the charging interface can in particular comprise fast charging, in particular be fast charging. Fast charging is, in one embodiment, charging with a power of at least 50 kW.

In particular for fast charging, the aforementioned advantages of the invention, in particular due to the physical boundary conditions, are particularly significant.

In one embodiment, in a supply operating state of the connecting apparatus, the first circuit, in a further development the first battery and/or the traction drive, is at least temporarily supplied with electrical energy from the second battery via the connecting apparatus, preferably in a driving operation of the motor vehicle (energy system), or the connecting apparatus is configured to do so or is used to do so, and the controller switches the connecting apparatus, in one embodiment after termination of the charging operating state, at least temporarily into this supply operating state, preferably on the basis of a state of charge of the first and/or second battery, in one embodiment if a state of charge of the first battery falls below a predefined limit value and/or a state of charge of the second battery and/or a power demand of the traction drive exceeds a predefined limit value, and/or if a preceding charging process has been terminated, or is configured to do so, in particular in terms of hardware and/or software, in particular in terms of programming.

If the connecting apparatus is (also) used to supply the first circuit with electrical energy from the second battery via the connecting apparatus during driving operation, the transferring of electrical energy from the first circuit to the second battery before a charging process can relieve the connecting apparatus during the charging process and thereby advantageously allow it to be designed to be simpler, smaller and/or less powerful as the case may be.

In one embodiment, the connecting apparatus has a voltage converter, in a further development a DC voltage converter (DC/DC converter), which, in particular in the transfer operating state and/or charging operating state of the connecting apparatus, at least temporarily converts an input voltage of the first circuit into an output voltage for supplying the second battery and/or, in particular in the supply operating state of the connecting apparatus, at least temporarily converts an input voltage from the second battery into an output voltage for supplying the first circuit, or is configured to do so or is used to do so. A switching of the connecting apparatus can comprise, in particular be, a switching of the or one or more of the voltage converters of the connecting apparatus.

In particular for such connecting apparatuses or voltage converters, the aforementioned advantages of the invention, in particular due to the physical boundary conditions, are particularly significant.

In one embodiment, the first battery has a greater rated voltage and/or charging voltage than the second battery. Additionally or alternatively, in one embodiment the first battery is a high-voltage battery, in a further development it has a rated voltage and/or charging voltage of at least 200 V, preferably at least 300 V. Accordingly, the first circuit can in particular be a high-voltage circuit. Additionally or alternatively, in one embodiment the second battery is a low-voltage battery, in a further development it has a rated voltage and/or charging voltage of at most 100 V, preferably at most 60 V, preferably a protective extra-low voltage. Accordingly, the voltage converter of the connecting apparatuses can in particular be a high-voltage/low-voltage voltage converter. The first battery and/or the second battery is preferably (respectively) a rechargeable or secondary battery or an accumulator.

In particular, for this purpose, the aforementioned advantages of the invention are particularly significant, in particular due to the physical boundary conditions.

In one embodiment, the controller predicts an imminent charging process, in a further development
on the basis of a state of charge of the first and/or second battery, in particular when falling below a predefined limit value; and/or
on the basis of a vehicle position, for example when approaching a charging station; and/or
on the basis of a vehicle speed, for example when falling below a predefined limit value; and/or
on the basis of a driver input, or is configured to do so, in particular in terms of hardware and/or software, in particular in terms of programming.

In one embodiment, the controller switches the connecting apparatus into the transfer operating state on the basis of this or a thus predicted imminent charging process, or is configured to do so, in particular in terms of hardware and/or software, in particular in terms of programming. Additionally or alternatively, the controller switches the connecting apparatus into the transfer operating state already before the start of a or this predicted imminent charging process, or is configured to do so, in particular in terms of hardware and/or software, in particular in terms of programming.

In this way, switching into the transfer operating state can be carried out (respectively, in particular in combination) in a particularly advantageous manner, in particular in a process-reliable and/or situation-adapted manner.

In one embodiment, in a further development, the second battery is retrofitted and/or arranged only temporarily in a motor vehicle with a motor vehicle energy system described here and/or in a trunk of a or the motor vehicle with a motor vehicle energy system described here.

In particular for such retrofitted and/or in a trunk and/or only temporarily provided second or range extender batteries, the aforementioned advantages of the invention are particularly significant, in particular due to the physical boundary conditions.

The motor vehicle or motor vehicle energy system is, in one embodiment, a(n energy system of or for a) battery electric vehicle or BEV or a(n energy system of or for a) plug-in hybrid electric vehicle or PHEV. For this purpose the the present invention is particularly advantageous, in particular due to the physical boundary conditions.

According to one embodiment of the present invention, (according to a method) for operating a motor vehicle energy system described here, the controller of the motor vehicle energy system switches the connecting apparatus of the motor vehicle energy system into the transfer operating state on the basis of a predicted imminent charging process of the first and/or second battery, preferably before the start of the charging process. In a further development, the controller additionally switches the connecting apparatus, in particular after the transfer operating state, into the charging operating state described here. In a further development, the controller additionally switches the connecting apparatus, in particular after the charging operating state, into the supply operating state described here. In a further development, the controller predicts an imminent charging process in the manner described here.

A controller within the meaning of the present invention may be implemented in terms of hardware and/or software, in particular having at least one processing unit, in particular a microprocessor unit (CPU—Central Processing Unit), graphics card (GPU—Graphics Processing Unit) or the like, preferably connected in terms of data or signal to a memory and/or bus system, in particular digital, and/or one or more programs or program modules, in particular one or more, preferably correspondingly programmed, computers. The processing unit may be configured to execute instructions implemented as a program stored in a memory system, to detect input signals from a data bus and/or to output output signals to a data bus. A memory system may have one or more, in particular different, storage media, in particular optical, magnetic, solid-state and/or other non-volatile media. The program may be configured such that it embodies or is capable of executing the methods described here, so that the processing unit can execute the steps of such methods and thereby in particular operate the motor vehicle energy system or switch the connecting apparatus. A computer program product may, in one embodiment, have, in particular be, an, in particular computer-readable and/or non-volatile, storage medium for storing a program or instructions or with a program stored thereon or with instructions stored thereon. In one embodiment, an execution of a program or its instructions by a or the system or a or the controller, in particular a computer or an arrangement of multiple computers, causes the system or the controller, in particular the computer or computers, to execute a method described here or one or more of its steps, or the program or the instructions are configured to do so.

In one embodiment, one or more, in particular all, steps of the method are fully or partially computer-implemented or one or more, in particular all, steps of the method are carried out fully or partially in an automated manner, in particular by the system.

### BRIEF DESCRIPTION OF THE FIGURES

Further advantages, features and advantageous further developments of the present invention will become apparent from the dependent claims and the exemplary embodiments. For this purpose, shown in part schematically:

FIG. 1: a motor vehicle with a motor vehicle energy system according to one embodiment of the present invention; and

FIG. 2: a method for operating a motor vehicle energy system according to one embodiment of the present invention.

### DETAILED DESCRIPTION

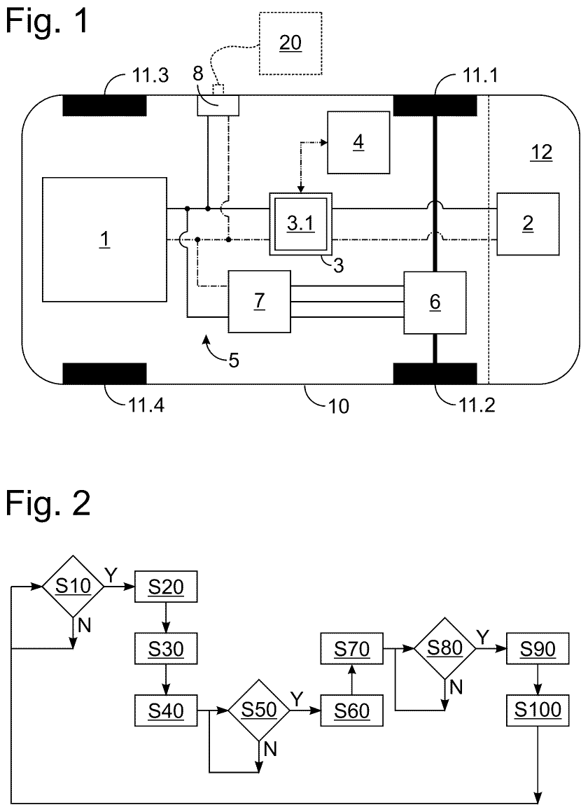

FIG. 1 shows a motor vehicle (10) with a motor vehicle energy system according to one embodiment of the present invention and vehicle wheels (11.1-11.4), of which in the exemplary embodiment at least two are driven by a traction drive with an electric motor (6).

The motor vehicle energy system has a first circuit (5) with a first or traction high-voltage battery (1), for example an 800 V (main) battery, for supplying the electric motor (6) of the traction drive with electrical energy via an inverter (7).

The motor vehicle energy system further has a second or range extender low-voltage battery (2), for example with a protective extra-low voltage of approx. 48 V, which can preferably be retrofitted and/or arranged in a trunk (12) of the motor vehicle (10).

The motor vehicle energy system further has a connecting apparatus (3) for electrically connecting the first circuit (5) and the second battery (2) with at least one DC/DC voltage converter (3.1) for converting an input voltage of the first circuit (5) into an output voltage for supplying the second battery (2) and for converting an input voltage from the second battery (2) into an output voltage for supplying the first circuit (5).

The motor vehicle energy system further has a controller (4).

During operation, the controller (4) predicts, for example when a state of charge of the first battery (1) and/or the second battery (2) falls below a predefined limit value (FIG. 2: step S10: “Y”), an imminent charging process of the first and/or second battery (FIG. 2: step S20).

In this case, the controller (4) switches the connecting apparatus (3) or the voltage converter (3.1) into a transfer operating state (FIG. 2: step S30), in which electrical energy is transferred via the connecting apparatus (3) or the voltage converter (3.1) from the first circuit (5), in particular the first battery (1), to the second battery (2) (FIG. 2: step S40).

For example, when a state of charge of the second battery (2) thereby exceeds a predefined limit value or (it is registered that) a charging interface (8) is connected to a charging station (20) (FIG. 2: step S50: “Y”), the controller switches the connecting apparatus (3) or the voltage converter (3.1) into a charging operating state (FIG. 2: step S60), in which the second battery (2) is now charged via the charging interface (8) and the connecting apparatus (3) or the voltage converter (3.1), wherein simultaneously the first battery (1) is also charged via the charging interface (8) (FIG. 2: step S70).

For example, when a state of charge of the first battery (1) and/or second battery (2) thereby exceeds a predefined limit value or (it is registered that) a user wishes to end the charging (FIG. 2: step S80: “Y”), the controller switches the connecting apparatus (3) or the voltage converter (3.1) into a supply operating state (FIG. 2: step S90), in which the second battery (2) makes electrical energy available to the first circuit (5) via the connecting apparatus (3) or the voltage converter (3.1) (FIG. 2: step S100).

Since the DC/DC voltage converter (3.1) is arranged between the high-voltage circuit (5) and the range extender battery (2), which preferably has a protective extra-low voltage so that a user can install it themselves, simultaneous charging, in particular fast charging, of the main battery (1) and range extender battery (2) has hitherto required a relatively large DC/DC voltage converter. However, such a large DC/DC voltage converter is not required during driving operation, but only during charging.

By already transferring, preferably as much as possible, energy from the main battery 1 into the range extender battery 2 as soon as it is detected that a charging station 20 is being approached, less energy needs to be charged into the range extender battery 2 and more energy into the main battery 1 during the subsequent charging or fast charging process. As a result, less energy needs to be transmitted to the range extender battery 2 during the fast charging or charging process in the same amount of time, so that both batteries reach the desired target state of charge. This in turn means that the DC/DC (Direct Current/Direct Current) voltage converter 3.1 can be made smaller and/or less expensive without any restriction of properties during fast charging.

In the present disclosure, “has an X” generally does not imply an exhaustive enumeration, but is a short form of “has at least one X” and also encompasses “has two or more X” as well as “has Y in addition to X”. Although exemplary embodiments have been explained in the preceding description, it should be noted that a large number of modifications are possible. Furthermore, it should be noted that the exemplary embodiments are merely examples that are not intended to restrict the scope of protection, the applications, and the structure in any way. Rather, the person skilled in the art is given a guide for the implementation of at least one exemplary embodiment by the preceding description, wherein various modifications, in particular with regard to the function and arrangement of the described components, may be made without departing from the scope of protection as it results from the claims and the combinations of features equivalent thereto.

### REFERENCE NUMERAL LIST

1 First battery
2 Second battery
3 Connecting apparatus
3.1 DC/DC voltage converter
4 Controller
5 First circuit
6 Electric motor
7 Inverter
8 Charging interface
10 Motor vehicle
11.1 Vehicle wheel
11.2 Vehicle wheel
11.3 Vehicle wheel
11.4 Vehicle wheel
12 Trunk
20 Charging station

1. A motor vehicle energy system, comprising:
a first circuit having a first battery for supplying a traction drive of a motor vehicle with electrical energy;
a second battery;
a connecting apparatus for connecting the first circuit and the second battery, which has a transfer operating state for transferring electrical energy from the first circuit to the second battery; and
a controller for switching the connecting apparatus into this transfer operating state on the basis of a predicted imminent charging process of the first and/or second battery.

2. The motor vehicle energy system according to claim 1, wherein:
the first circuit has a charging interface for charging the first battery; and
the connecting apparatus has a charging operating state for charging the second battery via the charging interface and the connecting apparatus and the controller is configured to switch the connecting apparatus into this charging operating state.

3. The motor vehicle energy system according to claim 1, wherein this charging of the first and second battery via the charging interface comprises fast charging.

4. The motor vehicle energy system according to claim 1, wherein:
the connecting apparatus has a supply operating state for supplying the first circuit with electrical energy from the second battery and the controller is configured to switch the connecting apparatus into this supply operating state; and/or
the connecting apparatus has a voltage converter for converting an input voltage of the first circuit into an output voltage for supplying the second battery and/or for converting an input voltage from the second battery into an output voltage for supplying the first circuit; and/or
the first battery has a greater rated voltage and/or charging voltage than the second battery and/or the first battery is a high-voltage battery and/or the second battery is a low-voltage battery.

5. The motor vehicle energy system according to claim 1, wherein the controller is configured to predict an imminent charging process and/or to switch the connecting apparatus into the transfer operating state on the basis of a predicted imminent charging process of the first and/or second battery before the start of the charging process.

6. The motor vehicle energy system according to claim 5, wherein the controller is configured to predict the charging process on the basis of a state of charge of the first and/or second battery and/or on the basis of a vehicle position and/or vehicle speed and/or on the basis of a driver input.

7. The motor vehicle energy system according to claim 1, wherein the second battery is retrofitted and/or is arranged in a trunk of a motor vehicle with the motor vehicle energy system and/or only temporarily in a motor vehicle with the motor vehicle energy system.

8. The motor vehicle energy system according to claim 1, having a traction drive.

9. A method for operating a motor vehicle energy system according to claim 1, wherein the controller switches the connecting apparatus into the transfer operating state on the basis of a predicted imminent charging process of the first and/or second battery.

10. A computer program product, wherein the computer program product contains instructions, stored on a computer-readable and/or non-volatile storage medium, which, upon execution by one or more computers or a motor vehicle energy system, causes the one or more computers or the system to carry out the method according to claim 9.

11. The motor vehicle energy system according to claim 2, wherein this charging of the first and second battery via the charging interface comprises fast charging.

12. The motor vehicle energy system according to claim 2, wherein:
the connecting apparatus has a supply operating state for supplying the first circuit with electrical energy from the second battery and the controller is configured to switch the connecting apparatus into this supply operating state; and/or
the connecting apparatus has a voltage converter for converting an input voltage of the first circuit into an output voltage for supplying the second battery and/or for converting an input voltage from the second battery into an output voltage for supplying the first circuit; and/or
the first battery has a greater rated voltage and/or charging voltage than the second battery and/or the first battery is a high-voltage battery and/or the second battery is a low-voltage battery.

13. The motor vehicle energy system according to claim 3, wherein:
the connecting apparatus has a supply operating state for supplying the first circuit with electrical energy from the second battery and the controller is configured to switch the connecting apparatus into this supply operating state; and/or
the connecting apparatus has a voltage converter for converting an input voltage of the first circuit into an output voltage for supplying the second battery and/or for converting an input voltage from the second battery into an output voltage for supplying the first circuit; and/or
the first battery has a greater rated voltage and/or charging voltage than the second battery and/or the first battery is a high-voltage battery and/or the second battery is a low-voltage battery.

14. The motor vehicle energy system according to claim 2, wherein the controller is configured to predict an imminent charging process and/or to switch the connecting apparatus into the transfer operating state on the basis of a predicted imminent charging process of the first and/or second battery before the start of the charging process.

15. The motor vehicle energy system according to claim 3, wherein the controller is configured to predict an imminent charging process and/or to switch the connecting apparatus into the transfer operating state on the basis of a predicted imminent charging process of the first and/or second battery before the start of the charging process.

16. The motor vehicle energy system according to claim 4, wherein the controller is configured to predict an imminent charging process and/or to switch the connecting apparatus into the transfer operating state on the basis of a predicted imminent charging process of the first and/or second battery before the start of the charging process.

17. The motor vehicle energy system according to claim 2, wherein the second battery is retrofitted and/or is arranged in a trunk of a motor vehicle with the motor vehicle energy system and/or only temporarily in a motor vehicle with the motor vehicle energy system.

18. The motor vehicle energy system according to claim 3, wherein the second battery is retrofitted and/or is arranged in a trunk of a motor vehicle with the motor vehicle energy system and/or only temporarily in a motor vehicle with the motor vehicle energy system.

19. The motor vehicle energy system according to claim 4, wherein the second battery is retrofitted and/or is arranged in a trunk of a motor vehicle with the motor vehicle energy system and/or only temporarily in a motor vehicle with the motor vehicle energy system.

20. The motor vehicle energy system according to claim 5, wherein the second battery is retrofitted and/or is arranged in a trunk of a motor vehicle with the motor vehicle energy system and/or only temporarily in a motor vehicle with the motor vehicle energy system.
